(19) United States
(12) Patent Application Publication
(10) Pub. No.: US 2015/0212974 A1
(43) Pub. Date: Jul. 30, 2015

(54) FAST AND AUTOMATED ARIMA MODEL INITIALIZATION

(71) Applicant: International Business Machines Corporation, Armonk, NY (US)

(72) Inventors: David A. Wood, III, Scarsdale, NY (US); Murtaza Zafer, White Plains, NY (US); Petros Zerfos, New York, NY (US)

(73) Assignee: INTERNATIONAL BUSINESS MACHINES CORPORATION, Armonk, NY (US)

(21) Appl. No.: 14/163,418

(22) Filed: Jan. 24, 2014

(51) Int. Cl. G06F 17/18

(52) U.S. Cl. CPC G06F 17/18

(57) ABSTRACT

The present disclosure relates generally to the field of ARIMA model initialization (e.g., fast and automated ARIMA model initialization). The ARIMA model initialization may be implemented in the form of systems, methods and/or algorithms. The process of one example begins by first trying to find a pure auto-regressive only model for the time-series data, then a pure moving-average only model and finally a mixed-model. At each step, if a model is found, the process exits, thus enabling a fast and automated initialization procedure.

This invention was made with Government support under Contract No.: 60NANB10D003 awarded by National Institute of Standards and Technology (NIST). The Government has certain rights in this invention.

### BACKGROUND

Time-series data is generated in many systems and often forms the basis for forecasting and predicting future events in these systems. For example, in a data-center, a monitoring system could generate tens to hundreds of thousands of time-series data, each representing the state of a particular component (e.g., CPU and memory utilization of servers, bandwidth utilization of the network links, etc.)

Auto-Regressive Integrated Moving-Average (“ARIMA”) is a class of statistical models used for modeling time-series data and forecasting future values of the time-series. Such modeling and forecasting can then be used for predicting events in the future and taking proactive actions and/or for detecting abnormal trend.

To be useful, the first step is typically to determine the parameters of an ARIMA model that best suit a particular time-series. This process is referred to as “ARIMA Initialization”. ARIMA initialization typically involves a tradeoff between computational complexity and accuracy of model fitting.

More specifically, an ARIMA(p,d,q) model consists of the following parameters: difference order (d), auto-regressive (“AR”) order (p) and moving-average (“MA”) order (q). Thus, ARIMA initialization involves computing the values of (p,d,q) that best fit a given time-series and furthermore computing the actual AR coefficients (ar_{—}1, . . . , ar_p) and the actual MA coefficients (ma_{—}1, . . . , ma_q).

### SUMMARY

The present disclosure relates generally to the field of ARIMA model initialization (e.g., fast and automated ARIMA model initialization).

In one embodiment a method implemented in a computer for model initialization in connection with modeling time-series data using an ARIMA model is provided, the method comprising: determining, by the computer, a difference order of the time-series data; differencing, by the computer, the time-series data to obtain differenced time-series data; determining, by the computer, whether the differenced time-series data is only auto-regressive time-series data; if it has been determined that the differenced time-series data is only auto-regressive time-series data, then determining, by the computer, an auto-regressive order associated with the differenced time-series data and at least one auto-regressive coefficient associated with the differenced time-series data; determining, by the computer, if it has been determined that the differenced time-series data is not only auto-regressive time-series data, whether the differenced time-series data is only moving-average time-series data; determining, by the computer, if it has been determined that the differenced time-series data is only moving-average time-series data, a moving-average order associated with the differenced time-series data and at least one moving-average coefficient associated with the differenced time-series data; and determining, by the computer, if it has been determined that the differenced time-series data is not only auto-regressive time-series data and is not only moving-average time-series data, a mixed order of the differenced time-series data, at least one moving-average coefficient associated with the differenced time-series data, and at least one auto-regressive coefficient associated with the differenced time-series data.

In another embodiment a computer readable storage medium, tangibly embodying a program of instructions executable by the computer for model initialization in connection with modeling time-series data using an ARIMA model is provided, the program of instructions, when executing, performing the following steps: determining a difference order of the time-series data; differencing the time-series data to obtain differenced time-series data; determining whether the differenced time-series data is only auto-regressive time-series data; if it has been determined that the differenced time-series data is only auto-regressive time-series data, then determining an auto-regressive order associated with the differenced time-series data and at least one auto-regressive coefficient associated with the differenced time-series data; determining, if it has been determined that the differenced time-series data is not only auto-regressive time-series data, whether the differenced time-series data is only moving-average time-series data; determining, if it has been determined that the differenced time-series data is only moving-average time-series data, a moving-average order associated with the differenced time-series data and at least one moving-average coefficient associated with the differenced time-series data; and determining, if it has been determined that the differenced time-series data is not only auto-regressive time-series data and is not only moving-average time-series data, a mixed order of the differenced time-series data, at least one moving-average coefficient associated with the differenced time-series data, and at least one auto-regressive coefficient associated with the differenced time-series data.

In another embodiment a computer-implemented system for model initialization in connection with modeling time-series data using an ARIMA model is provided, the system comprising: a first determining element configured to determine a difference order of the time-series data; a differencing element configured to difference the time-series data to obtain differenced time-series data; a second determining element configured to determine whether the differenced time-series data is only auto-regressive time-series data; a third determining element configured to determine, if it has been determined that the differenced time-series data is only auto-regressive time-series data, an auto-regressive order associated with the differenced time-series data and at least one auto-regressive coefficient associated with the differenced time-series data; a fourth determining element configured to determine, if it has been determined that the differenced time-series data is not only auto-regressive time-series data, whether the differenced time-series data is only moving-average time-series data; a fifth determining element configured to determine, if it has been determined that the differenced time-series data is only moving-average time-series data, a moving-average order associated with the differenced time-series data and at least one moving-average coefficient associated with the differenced time-series data; and a sixth determining element configured to determine, if it has been determined that the differenced time-series data is not only auto-regressive time-series data and is not only moving-average time-series data, a mixed order of the differenced time-series data, at least one moving-average coefficient associated with the differenced time-series data, and at least one auto-regressive coefficient associated with the differenced time-series data.

### BRIEF DESCRIPTION OF THE DRAWINGS

Various objects, features and advantages of the present invention will become apparent to one skilled in the art, in view of the following detailed description taken in combination with the attached drawings, in which:

FIG. 1 depicts a block diagram of a method according to an embodiment of the present invention.

FIGS. 2A and 2B depict a block diagram of a method according to an embodiment of the present invention.

FIG. 3 depicts a block diagram of a system according to an embodiment of the present invention.

FIG. 4 depicts a block diagram of a system according to an embodiment of the present invention.

FIG. 5 depicts a block diagram of a system according to an embodiment of the present invention.

### DETAILED DESCRIPTION

As described herein, ARIMA model initialization may be implemented in the form of systems, methods and/or algorithms.

For the purposes of describing and claiming the present invention the term “AR-only signature” is intended to refer to time-series characteristics which make the time-series an auto-regressive only time-series.

For the purposes of describing and claiming the present invention the term “MA-only signature” is intended to refer to time-series characteristics which make the time-series a moving-average only time-series.

As described herein, in one embodiment a three-step process (along with associated heuristics) is used for quickly identifying an order of an ARIMA model that would best fit a given time-series data. The process of this example begins by first trying to find a pure auto-regressive only (sometimes referred to herein as “AR-only”) model for the time-series data, then a pure moving-average only (sometimes referred to herein as “MA-only”) model and finally a mixed-model. At each step, if a model is found, the method exits, thus enabling a fast and automated initialization procedure.

In one specific example, the AR-only model determination uses a new heuristic (discussed in more detail below) to determine the model order based on the partial auto-correlation function computed from the data.

In another specific example, the MA-only model determination uses a new heuristic (discussed in more detail below) to determine the model order based on the auto-correlation function computed from the data.

In yet another specific example, the mixed model is determined using a grid search over a pre-determined set of model orders.

One advantage of operating as described herein in connection with various embodiments is that model fitting is fully automated and fast, and can be completely transparent to the user (thus providing ease-of-use for, e.g., any statistical forecasting service).

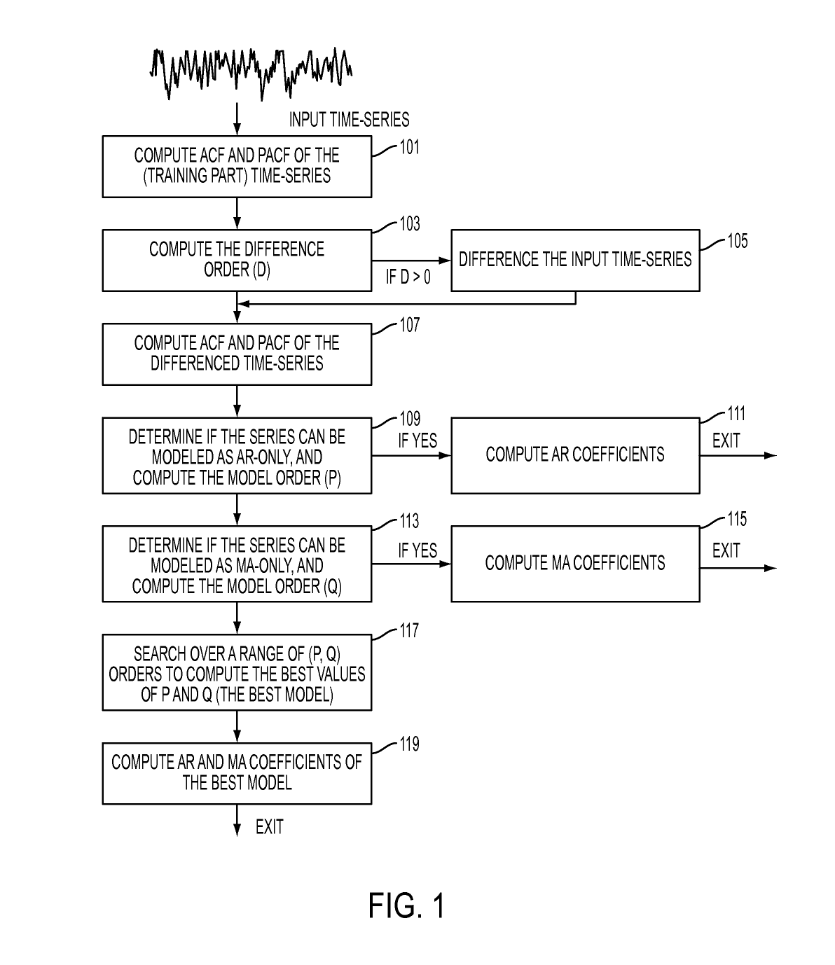

Referring now to FIG. 1, an example implementation according to an embodiment will be described. In this example implementation, an ARIMA initialization method is depicted in flowchart form. The input to this method is time-series data, which is a sequence of values indexed by time. The various steps of this method are as follows: Step 101—Compute the auto-correlation function (ACF) and the partial auto-correlation function (PACF) of the training part of the input time-series data (see, e.g., P. Brockwell, R. Davis, “Introduction to time series and forecasting”, Springer, 2nd edition, 2002 for methods for computing the ACF and PACF functions of a time-series); Step 103—Compute the difference order (d) that best fits the input time-series (one specific example of a heuristic based on the PACF function for computing the difference order is discussed in more detail below). If the best-fit d is positive, then the original time-series data is differenced (Step 105) by a factor d and passed as input to the next step of the method (otherwise no differencing is done on the time-series); Step 107—Compute the ACF and PACF of the differenced time-series; Step 109—Determine if the differenced time-series can be modeled as AR-only and, if so, compute the model order p (one specific example of a heuristic based on the PACF cutoff-point for performing Step 109 is discussed in more detail below), and then compute the AR coefficients of the model (Step 111) and exit the method; Otherwise, at Step 113—If Step 109 above fails, determine if the differenced time-series can be modeled as MA-only and, if so, compute the model order q (one specific example of a heuristic based on the ACF cutoff-point for performing Step 113 is discussed in more detail below), and then compute the MA coefficients of the model (Step 115) and exit the method; If Step 113 above step fails, perform a search over a set of (p,q) orders and compute the best values of p and q—referred to as the best model (Step 117). Step 119—Compute the AR and MA coefficients corresponding to the best model and exit.

Reference will now be made to a number of more detailed example steps which may be implemented in connection with the method of FIG. 1 discussed above. As previously mentioned, initializing an ARIMA(p,d,q) model involves determining the difference order d, the AR order p, the MA order q, the set of p AR coefficients and the set of q MA coefficients. Given a time series data X(t) (t=1, . . . , N), these parameters may be determined as follows:

Determining the difference order d—see Step 103 above. To determine the difference order the initial state is set such that d=0. Thereafter, the following steps are performed:

(1) Compute the PACF of the series X(t) at lag 1 (“lag 1” refers to the second term in the PACF vector). This is denoted as pacf₁₃ X(1).

(2) If pacf_X(1) >threshold, increment d by 1; else terminate.

(3) Difference the original time-series X(t) by order d, and repeat from Step (1).

The rationale behind using the above procedure follows from the observation that for a series with difference order 1, the PACF at lag 1 is very high and close to 1 (see P. Brockwell, R. Davis, “Introduction to time series and forecasting”, Springer, 2nd edition, 2002, page 182). One specific example of a value of an appropriate threshold is 0.96. Higher difference orders are determined by recursively computing the pacf at lag 1 of the differenced series, until its value is less than the threshold.

Determining the ARIMA parameters (p, q and the coefficients)—see Steps 107-119 above. After computing the difference order d from step 103 (and the detailed procedure described above), the series X(t) is differenced by d. This is denoted as X_diff(t). X_diff(t) is now modeled as an ARMA process to obtain its parameters as follows:

(1) Determine MEAN: compute mean of X_diff(t). This is the estimated mean of the ARMA model. Subtract mean from X_diff(t) to obtain a mean-corrected time series. Denote this as X_diff_meancorr(t).

(2) Check if X diff_meancorr(t) has a AR-only or a MA-only signature. Two parameters—max_ARonlyorder and max_MAonlyorder—are used as the maximum order for checking AR-only and MA-only signatures. One specific example of an appropriate value for these two parameters is 5. Next the system computes the ACF and PACF of X_diff_meancorr(t) up to maximum lag of 4*max(max_ARonlyorder,max_MAonlyorder), and then uses it to determine if there is an ARonly signature or an MAonly signature.

(2a) Computing pacf_cutoff-point: If a time-series is ARonly of order p, its sample pacf for lags greater than p are nearly zero; more specifically 95% of the lag values (absolute value) above lag p must be less than 1.96/sqrt(N), where N is the total number of samples in the time-series. (see P. Brockwell, R. Davis, “Introduction to time series and forecasting”, Springer, 2nd edition, 2002; pages 96, 141) This fact can be used for determining the order of a potential AR-only model. Define a pacf cutoff-point as the lag L at which the following two conditions are satisfied:

(i) pacf value (absolute value) at lag L is less than 1.96/sqrt(N), and

(ii) consider the number of lags from lag L till max-lag (including lag L), and obtain those pacf values (absolute value) that are not less than 1.96/sqrt(N). Denote these as violating-lags. The fraction, number-of-violating-lags/total-number-of-lags-from-lag_L-to-max-lag, must be less than or equal to 5%, and the absolute value of pacf at violating-lags must not be greater than 2*1.96/sqrt(N).

The process then proceeds serially starting from lag=1 until max-lag, and determines if the current lag is a pacf_cutoff-point as defined above. If the above two conditions are satisfied, this lag is labeled as the pacf_cutoff-point and this portion of the process terminates. If max-lag is reached and no lag can be classified as pacf_cutoff-point, it is determined that the time-series, X_diff_meancorr(t), is not a AR-only series.

(2b) Computing acf_cutoff-point: If a time-series is MAonly of order q, its sample acf for lags greater than q are nearly zero; more specifically 95% of the lag values (absolute value) above lag q must be less than 1.96/sqrt(N)*sqrt(1+2*(acf(1)̂2)+ . . . +2*(acf(q)̂2)), where N is the total number of samples in the time-series. (see P. Brockwell, R. Davis, “Introduction to time series and forecasting”, Springer, 2nd edition, 2002; page 152). This fact can be used for determining the order of a potential MA-only model. Denote the above value as acf_threshold_q. Note that in the ARonly case the threshold was fixed for all values of p, but in this embodiment the acf_threshold depends on the value of q.

As before, the process starts with lag=1 until max-lag, and for each lag determine if the current lag is a acf_cutoff-point as defined below.

A lag value L is defined as acf_cutoff-point if the following two conditions are satisfied:

(i) acf value (absolute value) at lag L is less than acf_threshold_q, where q is taken as q=L−1, and

(ii) consider the number of lags from lag L till max-lag (including lag L), and obtain those acf values (absolute value) that are not less than acf_threshold_q. Denote these as violating-lags. The fraction, number-of-violating-lags/total-number-of-lags-from-lagL-max-lag, must be less than or equal to 5%, and the absolute value of acf at violating-lags must not be greater than 2*acf_threshold_q.

If the above two conditions are satisfied, the current lag is labeled as the acf cutoff-point and this portion of the process terminates. If max-lag is reached and no lag can be classified as acf_cutoff-point, it is determined that the time-series, X_diff meancorr(t), is not a MA-only series.

(3) AR-only signature: computing AR coefficients: From step 2(a) above, obtain the pacf cutoff-point. If (pacf_cutoff-point−1)<maxARonlyorder, declare the model as AR-only. Assign p=(pacf_cutoff-point−1). Next, use the Yule-Walker method for determining the AR coefficients:

(3a) Yule-Walker method: see P. Brockwell, R. Davis, “Introduction to time series and forecasting”, Springer, 2nd edition, 2002; page 140—obtain the AR coefficients.

(3b) If sum(AR-coefficients) lies in [0.99, 1.01], declare model has a unit root at unity, and go to step 4 below for determining a MA-only or mixed model. Otherwise, return a AR-only model with the above calculated coefficients.

(4) MA-only signature: computing MA coefficients: From step 2(b) above, obtain the acf cutoff-point. If (acf_cutoff-point-1)<maxMAonlyorder, declare the model as MA-only. Assign q=(acf_cutoff-point-1). Next, use the Innovations method for determining the MA coefficients:

(4a) Innovations method: see P. Brockwell, R. Davis, “Introduction to time series and forecasting”, Springer, 2nd edition, 2002; pages 151,73—obtain the MA coefficients.

(4b) If sum(MA-coefficients) lies in [−0.99, −1.01], declare model has a unit root at unity, and go to step 5 below for determining a mixed model. Otherwise, return a MA-only model with the above calculated coefficients.

(5) Mixed model: If both steps 3 and 4 above do not return a pure AR or a pure MA model for the time-series, obtain a mixed model. Here, in this example, only mixed models up to order 2 are considered; i.e. max_p=2 and max_q=2. To obtain a mixed model, proceed as follows:

(5a) Consider a search over 1<p<2, and 1<q<2.

(5b) For each value of (p,q), use the Hannan-Rissanen algorithm to determine the AR and MA coefficient (see P. Brockwell, R. Davis, “Introduction to time series and forecasting”, Springer, 2nd edition, 2002; pages 156, 157). Once the coefficients are obtained, check for causality and invertibility by checking if the AR polynomials and MA polynomials have roots outside the unit circle (see P. Brockwell, R. Davis, “Introduction to time series and forecasting”, Springer, 2nd edition, 2002; pages 85, 86). The method then determines if the obtained model for this particular p,q is causal and invertible; if causal and invertible then store and/or output the model, otherwise it is discarded and the grid search is continued.

(5c) For each (p,q) for which a causal and invertible model is obtained, determine the Hannan-Rissanen estimate of the residual variance (see P. Brockwell, R. Davis, “Introduction to time series and forecasting”, Springer, 2nd edition, 2002; page 157). From among these models, pick the one with the lowest value of the Hannan-Rissanen estimate of residual variance. If no causal and invertible models are found, an error is output indicating that initialization failed.

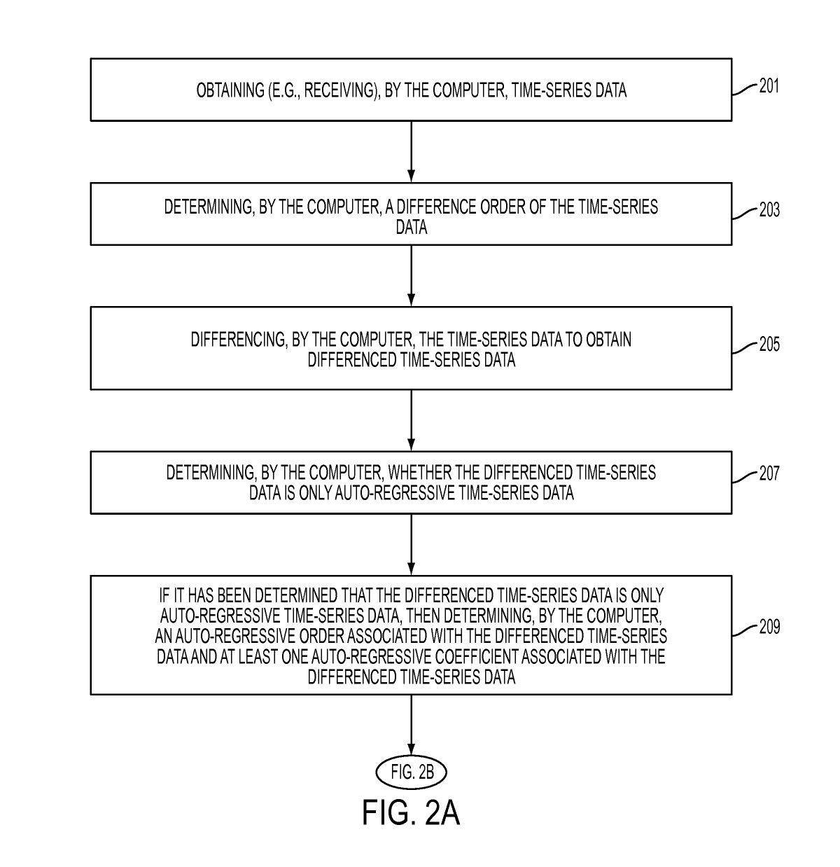

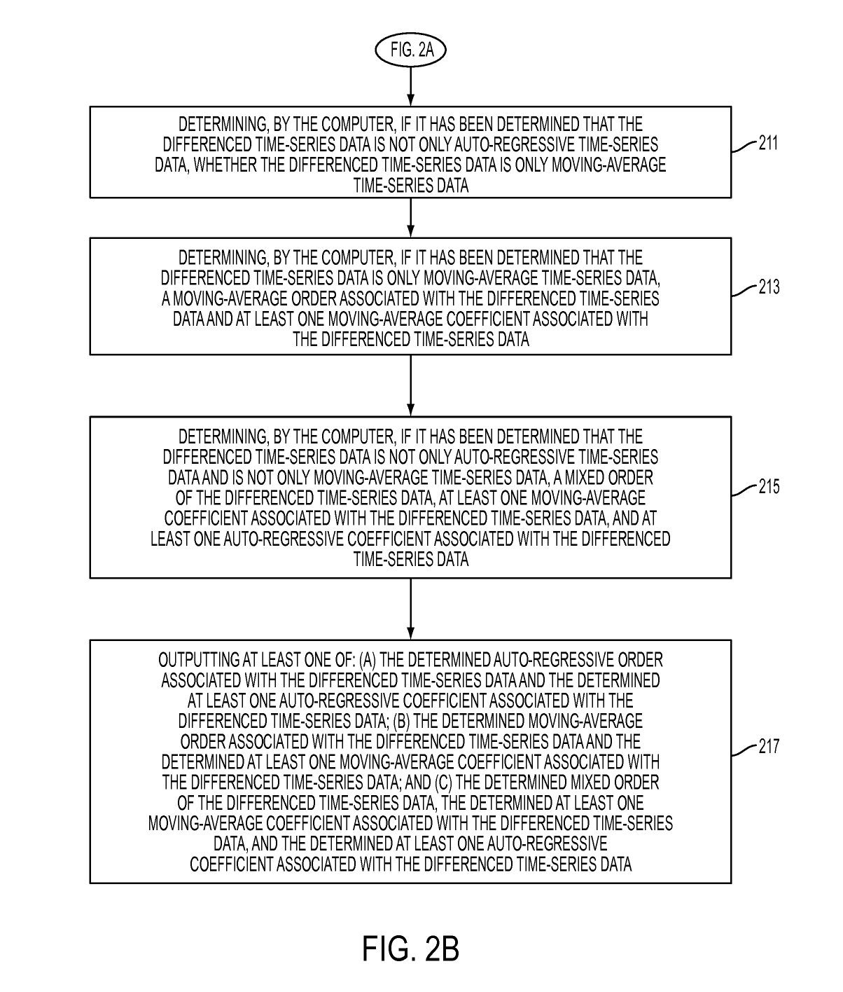

Referring now to FIGS. 2A and 2B, a method implemented in a computer for model initialization in connection with modeling time-series data using an ARIMA model is shown. As seen in these FIGS. 2A and 2B, the method of this embodiment comprises: at 201—obtaining (e.g., receiving), by the computer, time-series data; at 203—determining, by the computer, a difference order of the time-series data; at 205—differencing, by the computer, the time-series data to obtain differenced time-series data; at 207—determining, by the computer, whether the differenced time-series data is only auto-regressive time-series data; at 209—if it has been determined that the differenced time-series data is only auto-regressive time-series data, then determining, by the computer, an auto-regressive order associated with the differenced time-series data and at least one auto-regressive coefficient associated with the differenced time-series data; at 211—determining, by the computer, if it has been determined that the differenced time-series data is not only auto-regressive time-series data, whether the differenced time-series data is only moving-average time-series data; at 213—determining, by the computer, if it has been determined that the differenced time-series data is only moving-average time-series data, a moving-average order associated with the differenced time-series data and at least one moving-average coefficient associated with the differenced time-series data; at 215—determining, by the computer, if it has been determined that the differenced time-series data is not only auto-regressive time-series data and is not only moving-average time-series data, a mixed order of the differenced time-series data, at least one moving-average coefficient associated with the differenced time-series data, and at least one auto-regressive coefficient associated with the differenced time-series data; and at 217—outputting at least one of: (a) the determined auto-regressive order associated with the differenced time-series data and the determined at least one auto-regressive coefficient associated with the differenced time-series data; (b) the determined moving-average order associated with the differenced time-series data and the determined at least one moving-average coefficient associated with the differenced time-series data; and (c) the determined mixed order of the differenced time-series data, the determined at least one moving-average coefficient associated with the differenced time-series data, and the determined at least one auto-regressive coefficient associated with the differenced time-series data.

In one example, any steps may be carried out in the order recited or the steps may be carried out in another order.

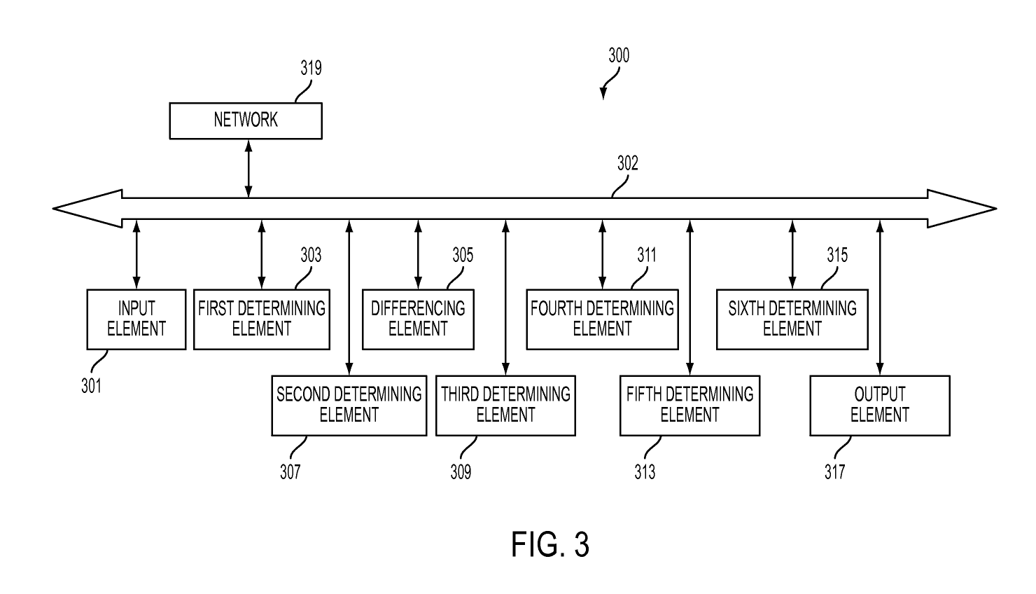

Referring now to FIG. 3, in another embodiment, a system 300 for model initialization in connection with modeling time-series data using an ARIMA model is provided. This system may include the following elements: an input element 301 configured to receive the time-series data; a first determining element 303 configured to determine a difference order of the time-series data; a differencing element 305 configured to difference the time-series data to obtain differenced time-series data; a second determining element 307 configured to determine whether the differenced time-series data is only auto-regressive time-series data; a third determining element 309 configured to determine, if it has been determined that the differenced time-series data is only auto-regressive time-series data, an auto-regressive order associated with the differenced time-series data and at least one auto-regressive coefficient associated with the differenced time-series data; a fourth determining element 311 configured to determine, if it has been determined that the differenced time-series data is not only auto-regressive time-series data, whether the differenced time-series data is only moving-average time-series data; a fifth determining element 313 configured to determine, if it has been determined that the differenced time-series data is only moving-average time-series data, a moving-average order associated with the differenced time-series data and at least one moving-average coefficient associated with the differenced time-series data; a sixth determining element 315 configured to determine, if it has been determined that the differenced time-series data is not only auto-regressive time-series data and is not only moving-average time-series data, a mixed order of the differenced time-series data, at least one moving-average coefficient associated with the differenced time-series data, and at least one auto-regressive coefficient associated with the differenced time-series data; and an output element 317 configured to output at least one of: (a) the determined auto-regressive order associated with the differenced time-series data and the determined at least one auto-regressive coefficient associated with the differenced time-series data; (b) the determined moving-average order associated with the differenced time-series data and the determined at least one moving-average coefficient associated with the differenced time-series data; and (c) the determined mixed order of the differenced time-series data, the determined at least one moving-average coefficient associated with the differenced time-series data, and the determined at least one auto-regressive coefficient associated with the differenced time-series data.

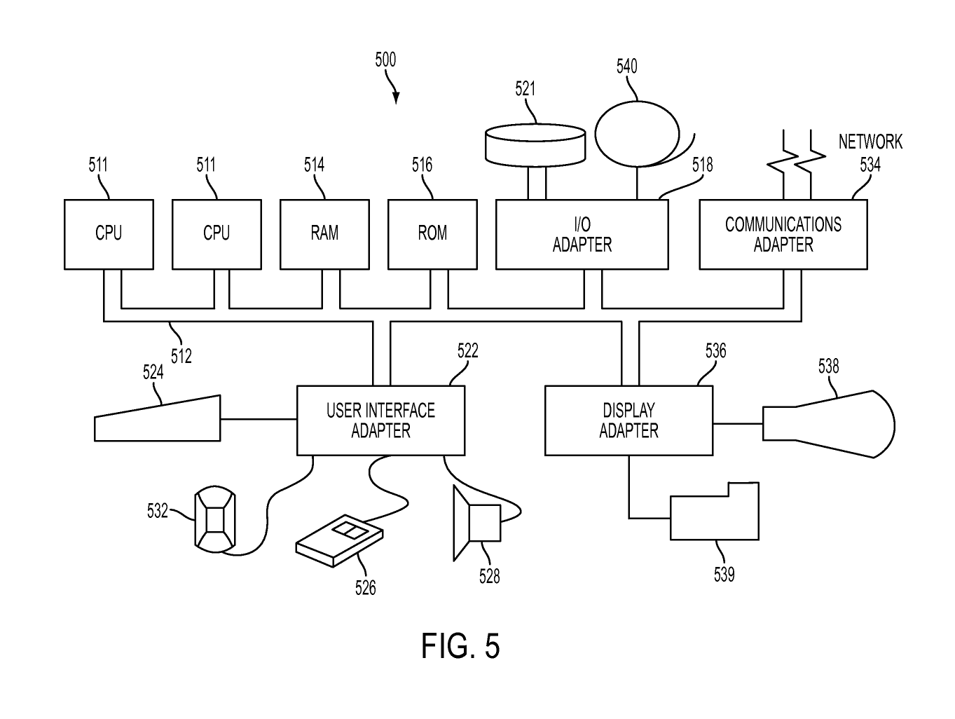

Still referring to FIG. 3, each of the elements may be operatively connected together via system bus 302. In one example, communication between and among the various elements may be bi-directional. In another example, communication may be carried out via network 319 (e.g., the Internet, an intranet, a local area network, a wide area network and/or any other desired communication channel(s)). In another example, some or all of these elements may be implemented in a computer system of the type shown in FIG. 5.

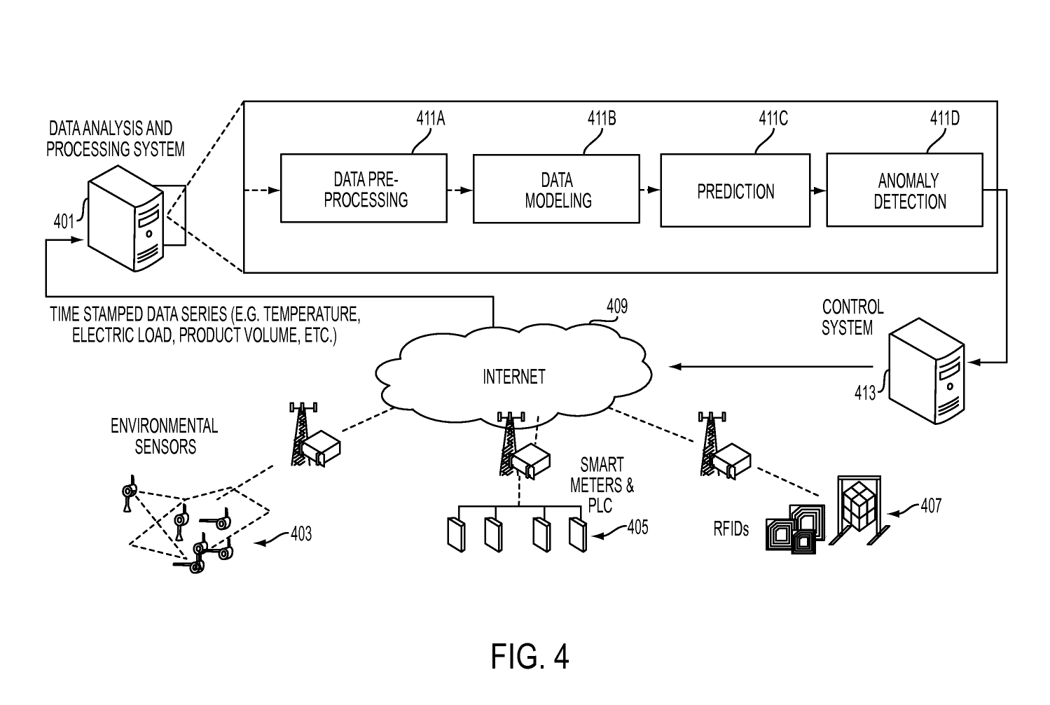

Referring now to FIG. 4, this figure shows a hardware configuration of a computing system according to another embodiment. As seen, a data analysis and processing system 401 is provided time stamped time-series data (e.g., temperature, electrical load, product volume) from a number of sources including for example, the following: environmental sensors 403 (e.g. related to petroleum and gas)), smart meters and power line communication (PLC) 405 (e.g., related to the power grid) and RFIDs 407 (e.g., related to manufacturing). The data may be provided to the data analysis and processing system 401 via the Internet 409 (using wired and/or wireless communication channels). The data analysis and processing system 401 may operate on the received data using functions such as the following: data pre-processing 411A, data modeling 411B, prediction 411C and anomaly detection 411D. An output from the data analysis and processing system 401 (e.g., based upon one or more of the above-mentioned functions) is provided to control system 413. Control system 413 then provides feedback via Internet 409 to each of environmental sensors 403, smart meters and PLC 405 and/or RFIDs 407.

Referring now to FIG. 5, this figure shows a hardware configuration of computing system 500 according to an embodiment of the present invention. As seen, this hardware configuration has at least one processor or central processing unit (CPU) 511. The CPUs 511 are interconnected via a system bus 512 to a random access memory (RAM) 514, read-only memory (ROM) 516, input/output (I/O) adapter 518 (for connecting peripheral devices such as disk units 521 and tape drives 540 to the bus 512), user interface adapter 522 (for connecting a keyboard 524, mouse 526, speaker 528, microphone 532, and/or other user interface device to the bus 512), a communications adapter 534 for connecting the system 500 to a data processing network, the Internet, an Intranet, a local area network (LAN), etc., and a display adapter 536 for connecting the bus 512 to a display device 538 and/or printer 539 (e.g., a digital printer or the like).

In another embodiment a method implemented in a computer for model initialization in connection with modeling time-series data using an ARIMA model is provided, the method comprising: determining, by the computer, a difference order of the time-series data; differencing, by the computer, the time-series data to obtain differenced time-series data; determining, by the computer, whether the differenced time-series data is only auto-regressive time-series data; if it has been determined that the differenced time-series data is only auto-regressive time-series data, then determining, by the computer, an auto-regressive order associated with the differenced time-series data and at least one auto-regressive coefficient associated with the differenced time-series data; determining, by the computer, if it has been determined that the differenced time-series data is not only auto-regressive time-series data, whether the differenced time-series data is only moving-average time-series data; determining, by the computer, if it has been determined that the differenced time-series data is only moving-average time-series data, a moving-average order associated with the differenced time-series data and at least one moving-average coefficient associated with the differenced time-series data; and determining, by the computer, if it has been determined that the differenced time-series data is not only auto-regressive time-series data and is not only moving-average time-series data, a mixed order of the differenced time-series data, at least one moving-average coefficient associated with the differenced time-series data, and at least one auto-regressive coefficient associated with the differenced time-series data.

In one example, the modeling of the time-series data is performed in connection with modeling of measurement data of a dynamic system.

In another example, the determining whether the differenced time-series data is only auto-regressive time-series data comprises: computing, by the computer, a partial auto-correlation function cutoff point; and checking, by the computer, whether the partial auto-correlation function cutoff point is below a pre-determined maximum auto-regressive order threshold.

In another example, the determining whether the differenced time-series data is only moving-average time-series data comprises: computing, by the computer, an auto-correlation function cutoff point; and checking, by the computer, whether the auto-correlation function cutoff point is below a pre-determined maximum moving-average order threshold.

In another example, the determining the difference order of the time-series data comprises recursively comparing, by the computer, a partial auto-correlation function lag 1 value with a pre-determined threshold.

In another example: the determining, by the computer, the at least one auto-regressive coefficient associated with the differenced time-series data further comprises determining, by the computer, a plurality of auto-regressive coefficients associated with the differenced time-series data; and the determining, by the computer, the at least one moving-average coefficient associated with the differenced time-series data further comprises determining, by the computer, a plurality of moving-average coefficients associated with the differenced time-series data.

In another example, the method further comprises outputting at least one of: (a) the determined auto-regressive order associated with the differenced time-series data and the determined at least one auto-regressive coefficient associated with the differenced time-series data; (b) the determined moving-average order associated with the differenced time-series data and the determined at least one moving-average coefficient associated with the differenced time-series data; and (c) the determined mixed order of the differenced time-series data, the determined at least one moving-average coefficient associated with the differenced time-series data, and the determined at least one auto-regressive coefficient associated with the differenced time-series data.

In another embodiment a computer readable storage medium, tangibly embodying a program of instructions executable by the computer for model initialization in connection with modeling time-series data using an ARIMA model is provided, the program of instructions, when executing, performing the following steps: determining a difference order of the time-series data; differencing the time-series data to obtain differenced time-series data; determining whether the differenced time-series data is only auto-regressive time-series data; if it has been determined that the differenced time-series data is only auto-regressive time-series data, then determining an auto-regressive order associated with the differenced time-series data and at least one auto-regressive coefficient associated with the differenced time-series data; determining, if it has been determined that the differenced time-series data is not only auto-regressive time-series data, whether the differenced time-series data is only moving-average time-series data; determining, if it has been determined that the differenced time-series data is only moving-average time-series data, a moving-average order associated with the differenced time-series data and at least one moving-average coefficient associated with the differenced time-series data; and determining, if it has been determined that the differenced time-series data is not only auto-regressive time-series data and is not only moving-average time-series data, a mixed order of the differenced time-series data, at least one moving-average coefficient associated with the differenced time-series data, and at least one auto-regressive coefficient associated with the differenced time-series data.

In one example, the modeling of the time-series data is performed in connection with modeling of measurement data of a dynamic system.

In another example, the determining whether the differenced time-series data is only auto-regressive time-series data comprises: computing a partial auto-correlation function cutoff point; and checking whether the partial auto-correlation function cutoff point is below a pre-determined maximum auto-regressive order threshold.

In another example, the determining whether the differenced time-series data is only moving-average time-series data comprises: computing an auto-correlation function cutoff point; and checking whether the auto-correlation function cutoff point is below a pre-determined maximum moving-average order threshold.

In another example, the determining the difference order of the time-series data comprises recursively comparing a partial auto-correlation function lag 1 value with a pre-determined threshold.

In another example: the determining the at least one auto-regressive coefficient associated with the differenced time-series data further comprises determining a plurality of auto-regressive coefficients associated with the differenced time-series data; and the determining the at least one moving-average coefficient associated with the differenced time-series data further comprises determining a plurality of moving-average coefficients associated with the differenced time-series data.

In another example, the program of instructions, when executing, further outputs at least one of: (a) the determined auto-regressive order associated with the differenced time-series data and the determined at least one auto-regressive coefficient associated with the differenced time-series data; (b) the determined moving-average order associated with the differenced time-series data and the determined at least one moving-average coefficient associated with the differenced time-series data; and (c) the determined mixed order of the differenced time-series data, the determined at least one moving-average coefficient associated with the differenced time-series data, and the determined at least one auto-regressive coefficient associated with the differenced time-series data.

In another embodiment a computer-implemented system for model initialization in connection with modeling time-series data using an ARIMA model is provided, the system comprising: a first determining element configured to determine a difference order of the time-series data; a differencing element configured to difference the time-series data to obtain differenced time-series data; a second determining element configured to determine whether the differenced time-series data is only auto-regressive time-series data; a third determining element configured to determine, if it has been determined that the differenced time-series data is only auto-regressive time-series data, an auto-regressive order associated with the differenced time-series data and at least one auto-regressive coefficient associated with the differenced time-series data; a fourth determining element configured to determine, if it has been determined that the differenced time-series data is not only auto-regressive time-series data, whether the differenced time-series data is only moving-average time-series data; a fifth determining element configured to determine, if it has been determined that the differenced time-series data is only moving-average time-series data, a moving-average order associated with the differenced time-series data and at least one moving-average coefficient associated with the differenced time-series data; and a sixth determining element configured to determine, if it has been determined that the differenced time-series data is not only auto-regressive time-series data and is not only moving-average time-series data, a mixed order of the differenced time-series data, at least one moving-average coefficient associated with the differenced time-series data, and at least one auto-regressive coefficient associated with the differenced time-series data.

In one example, the modeling of the time-series data is performed in connection with modeling of measurement data of a dynamic system.

In another example, the second determining element is configured to determine whether the differenced time-series data is only auto-regressive time-series data by: computing a partial auto-correlation function cutoff point; and checking whether the partial auto-correlation function cutoff point is below a pre-determined maximum auto-regressive order threshold.

In another example, the fourth determining element is configured to determine whether the differenced time-series data is only moving-average time-series data by: computing an auto-correlation function cutoff point; and checking whether the auto-correlation function cutoff point is below a pre-determined maximum moving-average order threshold.

In another example, the first determining element is configured to determine the difference order of the time-series data by recursively comparing a partial auto-correlation function lag 1 value with a pre-determined threshold.

In another example, the system further comprises: an input element configured to receive the time-series data; and an output element configured to output at least one of: (a) the determined auto-regressive order associated with the differenced time-series data and the determined at least one auto-regressive coefficient associated with the differenced time-series data; (b) the determined moving-average order associated with the differenced time-series data and the determined at least one moving-average coefficient associated with the differenced time-series data; and (c) the determined mixed order of the differenced time-series data, the determined at least one moving-average coefficient associated with the differenced time-series data, and the determined at least one auto-regressive coefficient associated with the differenced time-series data.

In other examples, any steps described herein may be carried out in any appropriate desired order.

As described herein, various embodiments provide mechanisms for ARIMA initialization in which: (a) the mechanisms are fully automated, fast, and accurate; and (b) in which the mechanisms do not necessarily require any input from the user for model initialization (e.g., do not require input from the user regarding the model orders—which in practice may not be available or may be guessed by the user.).

From a user perspective, such automated mechanisms provide strong capabilities and ease-of-use for any statistical forecasting service, as it can make the process of statistical modeling and forecasting essentially transparent to the user.

In other embodiments, user input (e.g., input from the user regarding the model orders) may be utilized.

As described herein, various embodiments may operate in the context of: analytics & optimization (e.g., analytic methods, including applications, such as supply chain management, as well as numeric data mining, economic methods/models); Cloud: Resource enablement: Provisioning, deployment, elasticity and workload management; Cloud: Resource enablement: Usage metering; Industrial: Data analytics and modeling; Smarter Planet: Resource management Software: Information and data management; Systems & software management.

As described herein, various embodiments utilize the ACF and PACF values in a set of steps to compute the model parameters. In one example, the steps may be scalable and may provide fast and accurate model initialization (which is crucial for high throughput systems). In another example, the steps may not require iterative parameter computation. In another example, mechanisms may be provided for determining the parameters of an ARIMA forecasting model. In another example, the disclosed mechanisms may be applied to application services such as streaming applications (e.g., modeling of streaming data) based on heuristics of ACF/PACF. In another example, the disclosed mechanisms may be applied to model and/or parameter selection. In another example, the disclosed mechanisms may be applied to real-time parameter estimation for ARIMA models. In another example, the disclosed mechanisms may be applied to early-deciding on whether certain components of the ARIMA model are needed with respect to the modeling of the underlying data or can be discarded early, so as to avoid expensive initialization/estimation of parameters for the respective component that might not be needed.

As described herein, various mechanisms: enable the use of a class of forecasting models in operational (automated) predictive analytics scenarios; enable predictive modeling/analysis of a large number of dynamic time-series (e.g., radio and network monitoring data; mobile device data, Internet data, RFID tag data); and eliminate the need for an analyst. In one specific example, operational analysis of time-series data may be provided in connection with high-throughput and low latency processing. In another specific example, operational analysis of time-series data may be provided in a fast and automated manner. In another specific example, predictive analytics (e.g., future predictions based on past events) may be based on observations of a system and may provide feedback of actions to be performed. In another specific example, questions that may be answered include: (a) What are realistic baselines for my environment?; (b) Can an early warning of an outage be provided?; (c) What will the resource consumption be in 5 minutes?

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any programming language or any combination of one or more programming languages, including an object oriented programming language such as Java, Smalltalk, C++ or the like or a procedural programming language, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described herein with reference to flowchart illustrations and/or block diagrams of methods, systems and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus or other devices provide processes for implementing the functions/acts specified in the flowchart and/or block diagram block or blocks.

The flowcharts and block diagrams in the figures illustrate the architecture, functionality, and operation of possible implementations of systems, methods and computer program products according to various embodiments of the present invention. In this regard, each block in the flowcharts or block diagrams may represent a module, segment, or portion of code, which comprises one or more executable instructions for implementing the specified logical function(s). It should also be noted that, in some implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

It is noted that the foregoing has outlined some of the objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the features and applications of the invention. Other beneficial results can be realized by applying the disclosed invention in a different manner or modifying the invention in ways known to those familiar with the art. In addition, all of the examples disclosed herein are intended to be illustrative, and not restrictive.

What is claimed is:

1. A method implemented in a computer for model initialization in connection with modeling time-series data using an ARIMA model, the method comprising:
determining, by the computer, a difference order of the time-series data;
differencing, by the computer, the time-series data to obtain differenced time-series data;
determining, by the computer, whether the differenced time-series data is only auto-regressive time-series data;
if it has been determined that the differenced time-series data is only auto-regressive time-series data, then determining, by the computer, an auto-regressive order associated with the differenced time-series data and at least one auto-regressive coefficient associated with the differenced time-series data;
determining, by the computer, if it has been determined that the differenced time-series data is not only auto-regressive time-series data, whether the differenced time-series data is only moving-average time-series data;
determining, by the computer, if it has been determined that the differenced time-series data is only moving-average time-series data, a moving-average order associated with the differenced time-series data and at least one moving-average coefficient associated with the differenced time-series data; and
determining, by the computer, if it has been determined that the differenced time-series data is not only auto-regressive time-series data and is not only moving-average time-series data, a mixed order of the differenced time-series data, at least one moving-average coefficient associated with the differenced time-series data, and at least one auto-regressive coefficient associated with the differenced time-series data.

2. The method of claim 1, wherein the modeling of the time-series data is performed in connection with modeling of measurement data of a dynamic system.

3. The method of claim 1, wherein the determining whether the differenced time-series data is only auto-regressive time-series data comprises:
computing, by the computer, a partial auto-correlation function cutoff point; and
checking, by the computer, whether the partial auto-correlation function cutoff point is below a pre-determined maximum auto-regressive order threshold.

4. The method of claim 1, wherein the determining whether the differenced time-series data is only moving-average time-series data comprises:
computing, by the computer, an auto-correlation function cutoff point; and
checking, by the computer, whether the auto-correlation function cutoff point is below a pre-determined maximum moving-average order threshold.

5. The method of claim 1, wherein the determining the difference order of the time-series data comprises recursively comparing, by the computer, a partial auto-correlation function lag 1 value with a pre-determined threshold.

6. The method of claim 1, wherein:
the determining, by the computer, the at least one auto-regressive coefficient associated with the differenced time-series data further comprises determining, by the computer, a plurality of auto-regressive coefficients associated with the differenced time-series data; and
the determining, by the computer, the at least one moving-average coefficient associated with the differenced time-series data further comprises determining, by the computer, a plurality of moving-average coefficients associated with the differenced time-series data.

7. The method of claim 1, further comprising outputting at least one of:
(a) the determined auto-regressive order associated with the differenced time-series data and the determined at least one auto-regressive coefficient associated with the differenced time-series data;
(b) the determined moving-average order associated with the differenced time-series data and the determined at least one moving-average coefficient associated with the differenced time-series data; and
(c) the determined mixed order of the differenced time-series data, the determined at least one moving-average coefficient associated with the differenced time-series data, and the determined at least one auto-regressive coefficient associated with the differenced time-series data.

8. A computer readable storage medium, tangibly embodying a program of instructions executable by the computer for model initialization in connection with modeling time-series data using an ARIMA model, the program of instructions, when executing, performing the following steps:
determining a difference order of the time-series data;
differencing the time-series data to obtain differenced time-series data;
determining whether the differenced time-series data is only auto-regressive time-series data;
if it has been determined that the differenced time-series data is only auto-regressive time-series data, then determining an auto-regressive order associated with the differenced time-series data and at least one auto-regressive coefficient associated with the differenced time-series data;
determining, if it has been determined that the differenced time-series data is not only auto-regressive time-series data, whether the differenced time-series data is only moving-average time-series data;
determining, if it has been determined that the differenced time-series data is only moving-average time-series data, a moving-average order associated with the differenced time-series data and at least one moving-average coefficient associated with the differenced time-series data; and
determining, if it has been determined that the differenced time-series data is not only auto-regressive time-series data and is not only moving-average time-series data, a mixed order of the differenced time-series data, at least one moving-average coefficient associated with the differenced time-series data, and at least one auto-regressive coefficient associated with the differenced time-series data.

9. The computer readable storage medium of claim 8, wherein the modeling of the time-series data is performed in connection with modeling of measurement data of a dynamic system.

10. The computer readable storage medium of claim 8, wherein the determining whether the differenced time-series data is only auto-regressive time-series data comprises:
computing a partial auto-correlation function cutoff point; and
checking whether the partial auto-correlation function cutoff point is below a pre-determined maximum auto-regressive order threshold.

11. The computer readable storage medium of claim 8, wherein the determining whether the differenced time-series data is only moving-average time-series data comprises:
computing an auto-correlation function cutoff point; and
checking whether the auto-correlation function cutoff point is below a pre-determined maximum moving-average order threshold.

12. The computer readable storage medium of claim 8, wherein the determining the difference order of the time-series data comprises recursively comparing a partial auto-correlation function lag 1 value with a pre-determined threshold.

13. The computer readable storage medium of claim 8, wherein:
the determining the at least one auto-regressive coefficient associated with the differenced time-series data further comprises determining a plurality of auto-regressive coefficients associated with the differenced time-series data; and
the determining the at least one moving-average coefficient associated with the differenced time-series data further comprises determining a plurality of moving-average coefficients associated with the differenced time-series data.

14. The computer readable storage medium of claim 8, wherein the program of instructions, when executing, further outputs at least one of:
(a) the determined auto-regressive order associated with the differenced time-series data and the determined at least one auto-regressive coefficient associated with the differenced time-series data;
(b) the determined moving-average order associated with the differenced time-series data and the determined at least one moving-average coefficient associated with the differenced time-series data; and
(c) the determined mixed order of the differenced time-series data, the determined at least one moving-average coefficient associated with the differenced time-series data, and the determined at least one auto-regressive coefficient associated with the differenced time-series data.

15. A computer-implemented system for model initialization in connection with modeling time-series data using an ARIMA model, the system comprising:
a first determining element configured to determine a difference order of the time-series data;
a differencing element configured to difference the time-series data to obtain differenced time-series data;
a second determining element configured to determine whether the differenced time-series data is only auto-regressive time-series data;
a third determining element configured to determine, if it has been determined that the differenced time-series data is only auto-regressive time-series data, an auto-regressive order associated with the differenced time-series data and at least one auto-regressive coefficient associated with the differenced time-series data;
a fourth determining element configured to determine, if it has been determined that the differenced time-series data is not only auto-regressive time-series data, whether the differenced time-series data is only moving-average time-series data;
a fifth determining element configured to determine, if it has been determined that the differenced time-series data is only moving-average time-series data, a moving-average order associated with the differenced time-series data and at least one moving-average coefficient associated with the differenced time-series data; and
a sixth determining element configured to determine, if it has been determined that the differenced time-series data is not only auto-regressive time-series data and is not only moving-average time-series data, a mixed order of the differenced time-series data, at least one moving-average coefficient associated with the differenced time-series data, and at least one auto-regressive coefficient associated with the differenced time-series data.

16. The system of claim 15, wherein the modeling of the time-series data is performed in connection with modeling of measurement data of a dynamic system.

17. The system of claim 15, wherein the second determining element is configured to determine whether the differenced time-series data is only auto-regressive time-series data by:
computing a partial auto-correlation function cutoff point; and
checking whether the partial auto-correlation function cutoff point is below a pre-determined maximum auto-regressive order threshold.

18. The system of claim 15, wherein the fourth determining element is configured to determine whether the differenced time-series data is only moving-average time-series data by:
computing an auto-correlation function cutoff point; and
checking whether the auto-correlation function cutoff point is below a pre-determined maximum moving-average order threshold.

19. The system of claim 15, wherein the first determining element is configured to determine the difference order of the time-series data by recursively comparing a partial auto-correlation function lag 1 value with a pre-determined threshold.

20. The system of claim 15, further comprising:
an input element configured to receive the time-series data; and
an output element configured to output at least one of:
(a) the determined auto-regressive order associated with the differenced time-series data and the determined at least one auto-regressive coefficient associated with the differenced time-series data;
(b) the determined moving-average order associated with the differenced time-series data and the determined at least one moving-average coefficient associated with the differenced time-series data; and
(c) the determined mixed order of the differenced time-series data, the determined at least one moving-average coefficient associated with the differenced time-series data, and the determined at least one auto-regressive coefficient associated with the differenced time-series data.
